(19) United States
(12) Patent Application Publication
(10) Pub. No.: US 2026/0211480 A1
(43) Pub. Date: Jul. 23, 2026

(54) INTEGRATED CIRCUIT PERFORMING DYNAMIC VOLTAGE AND FREQUENCY SCALING OPERATION FOR HIGH TEMPERATURE PREVENTION, OPERATING METHOD OF THE INTEGRATED CIRCUIT AND SYSTEM

(71) Applicant: Samsung Electronics Co., Ltd., Suwon-si (KR)

(72) Inventor: Kyungmin Park, Suwon-si (KR)

(21) Appl. No.: 19/445,893

(22) Filed: Jan. 12, 2026

(30) Foreign Application Priority Data
Jan. 17, 2025 (KR) 10-2025-0007553

(51) Int. Cl. G06F 1/324; G06F 1/20; G06F 1/3296

(52) U.S. Cl. CPC G06F 1/324; G06F 1/206; G06F 1/3296

(57) ABSTRACT

An integrated circuit includes an intellectual property (IP) block and a dynamic voltage and frequency scaling (DVFS) controller configured to calculate a workload of the IP block and control an operating frequency provided to the IP block for processing the workload, in which the DVFS controller may be configured to determine a post-operating frequency based on at least one pre-operating frequency provided to the IP block and a frequency pattern corresponding to a number of cycles during which the at least one pre-operating frequency is provided to the IP block, and to provide the post-operating frequency to the IP block during a number of cycles equal to or less than a threshold cycle corresponding to the post-operating frequency based on the frequency pattern.

### CROSS-REFERENCE TO RELATED APPLICATION

This application is based on and claims priority under 35 U.S.C. § 119 to Korean Patent Application No. 10-2025-0007553, filed on Jan. 17, 2025, in the Korean Intellectual Property Office, the disclosure of which is incorporated by reference herein in its entirety.

### BACKGROUND

As integrated circuit technologies advance and integration densities increase, importance of power management for integrated circuits and integrated circuit-based devices becomes more significant. In particular, power consumption may affect operating temperatures of integrated circuits, and performance degradation of integrated circuits due to heat generation may also be fatal.

As the number of IP blocks (chips) included in integrated circuits increases, the complexity of power and heat management also increases. Therefore, technologies for managing power consumption and heat generation of various IP blocks are desired. DVFS operations may be performed to dynamically control operating voltages and operating frequencies for power and heat management. For example, temperatures of IP blocks may increase due to heat generation from high operating frequencies, and thus, lower operating frequencies may be used to reduce the temperatures of the IP blocks. Lowering the operating frequencies provided to IP blocks may result in a loss of performance in mobile devices as perceived by users. Therefore, research is being conducted on methods to perform throttling on system-on-chips (SoCs) while minimizing performance degradation in mobile devices as perceived by users. The SoCs refer to integrated circuits in which computer or electronic system components are integrated and may generally be used primarily in embedded system applications.

### SUMMARY

In general, the present disclosure is directed toward an integrated circuit for determining an operating frequency to be used, based on patterns of operating frequencies, in order to address performance degradation due to increases in temperatures of intellectual property (IP) blocks, an operating method of the integrated circuit, and a system.

According to some implementations, the present disclosure is directed to an integrated circuit that includes an IP block, and a dynamic voltage and frequency scaling (DVFS) controller configured to calculate a workload of the IP block and control an operating frequency provided to the IP block for processing the workload, wherein the DVFS controller is further configured to determine a post-operating frequency based on at least one pre-operating frequency provided to the IP block and a frequency pattern corresponding to a number of cycles during which the at least one pre-operating frequency is provided to the IP block, and provide the post-operating frequency to the IP block based on the frequency pattern, during a number of cycles equal to or less than a threshold cycle corresponding to the post-operating frequency.

According to some implementations, the present disclosure is directed to an operating method of an integrated circuit, the operating method including calculating a workload of an IP block, providing a first operating frequency to the IP block corresponding to the calculated workload, processing the workload based on the first operating frequency, determining whether at least one operating frequency provided to the IP block during the processing of the workload, and a number of cycles during which the at least one operating frequency is provided, correspond to a frequency pattern, and providing a second operating frequency to the IP block, based on a determination of the correspondence to the frequency pattern.

According to some implementations, the present disclosure is directed to a system that includes an IP block, a DVFS controller configured to calculate a workload of the IP block and control an operating frequency provided to the IP block for processing the workload, wherein the DVFS controller is further configured to determine a predetermined frequency pattern, before a first time point, corresponding to at least one pre-operating frequency provided to the IP block and a number of cycles during which the at least one pre-operating frequency is provided, determine a post-operating frequency at the first time point based on the predetermined frequency pattern, and provide the post-operating frequency to the IP block.

### BRIEF DESCRIPTION OF THE DRAWINGS

Example implementations will be more clearly understood from the following detailed explanation, taken in conjunction with the accompanying drawings.

FIG. 1 is a block diagram illustrating an example of an integrated circuit according to some implementations.

FIG. 2 is a block diagram illustrating examples of dynamic voltage and frequency scaling (DVFS) operation according to some implementations.

FIG. 3 is a diagram illustrating an example of a relationship between workloads and operating frequencies according to some implementations.

FIG. 4 is a graph illustrating examples of temperatures of an intellectual property (IP) block according to operating frequencies according to some implementations.

FIG. 5 is a graph illustrating an example of a DVFS operation according to some implementations.

FIG. 6 is a diagram illustrating an example of a DVFS table according to some implementations.

FIG. 7 is a block diagram illustrating an example of a DVFS operation according to some implementations.

FIG. 8 is a diagram illustrating an example of a DVFS table according to some implementations.

FIG. 9 is a block diagram illustrating an example of a DVFS operation according to some implementations

FIG. 10 is a diagram illustrating an example of a DVFS neural network according to some implementations

FIG. 11 is a flowchart illustrating an example of an operating method of an integrated circuit according to some implementations.

FIG. 12 is a block diagram illustrating an example of a system according to some implementations.

FIG. 13 is a block diagram illustrating an example of an electronic device including an application processor according to some implementations.

### DETAILED DESCRIPTION

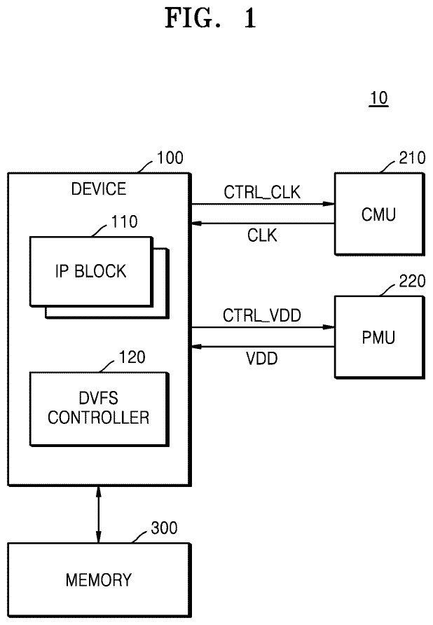

FIG. 1 is a block diagram illustrating an example of an integrated circuit according to some implementations. In FIG. 1, an integrated circuit 10 may include a device 100, a clock management unit (CMU) 210, a power management unit (PMU) 220, and a memory 300. In some implementations, at least some of the device 100, the CMU 210, the PMU 220, and the memory 300 may be included in a single semiconductor package. In some implementations, the device 100, the CMU 210, the PMU 220, and the memory 300 may be included in a single chip, i.e., a system-on-chip (SoC), and the integrated circuit 10 may be referred to as an application processor (AP).

The integrated circuit 10 may include a system bus to which a protocol having a predetermined standard bus specification is applied, and may include various intellectual properties (IPs) connected to the system bus. As a standard specification for the system bus, the Advanced Microcontroller Bus Architecture (AMBA) protocol of Advanced RISC Machine (ARM) may be applied. Bus types of the AMBA protocol may include Advanced High-Performance Bus (AHB), Advanced Peripheral Bus (APB), Advanced eXtensible Interface (AXI), AXI4, and AXI Coherency Extensions (ACE).

The integrated circuit 10 may be a stationary computing system, such as a desktop personal computer (PC) or a server, or may correspond to a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or a portable navigation device (PND), a handheld game console, a mobile internet device (MID), a wearable computer, an Internet of Things (IoT) device, an Internet of Everything (IoE) device, or an e-book.

The device 100 may include a plurality of IP blocks 110 and a dynamic voltage and frequency scaling (DVFS) controller 120. The device 100 may control the integrated circuit 10 and may be referred to as a processor, a host processor, a host device, etc. In some implementations, the device 100 may include the plurality of IP blocks 110 for executing a series of instructions, and may run a program consisting of commands. The program may include a plurality of subprograms, and the subprogram may be referred to as a subroutine, routine, procedure, function, etc.

In some implementations, the device 100 may be designed as an integrated circuit implemented with a plurality of transistors. The device 100 may be, for example, a central processing unit (CPU), a graphics processing unit (GPU), a neural processing unit (NPU), or an image signal processor (ISP). Although FIG. 1 illustrates one device 100, types and numbers of devices 100 included in the integrated circuit 10 are not limited thereto. In some implementations, the DVFS controller 120 may be located external to the device 100.

Each of the plurality of IP blocks 110 may independently process commands. Each of the plurality of IP blocks 110 may be a CPU core, a GPU core, an NPU core, or an ISP core. Since the device 100 includes multiple cores, the integrated circuit 10 may also be referred to as a multi-core processor. The IP block may also be referred to as a sub function block.

Each of the plurality of IP blocks 110 may process commands according to a clock signal CLK and a supply voltage VDD (or voltage-frequency level). Performance of each of the plurality of IP blocks may depend on the clock signal CLK and the supply voltage VDD. As the magnitude of the supply voltage VDD provided to each of the plurality of IP blocks 110 increases and the frequency of the clock signal CLK increases, performance of the device 100 may be improved, but power consumed by each of the plurality of IP blocks 110 may increase, and temperature of each of the plurality of IP blocks 110 may rise. However, in some IP blocks, power consumption may decrease despite an increase in the frequency of the clock signal CLK, depending on power characteristics (or chip-specific properties), such as dynamic power and/or static power.

For convenience of description, in the present disclosure, the frequency of the clock signal CLK may be referred to as an operating frequency, and the level of the supply voltage VDD may be referred to as an operating voltage.

The integrated circuit 10 may determine operating frequencies to be provided to the plurality of IP blocks 110, based on the patterns of the operating frequency provided to the plurality of IP blocks 110, to manage heat generation of each of the plurality of IP blocks 110.

To minimize performance degradation (that is, to avoid a high temperature state) by managing the heat generation of each of the plurality of IP blocks 110, the integrated circuit 10 may control the operating frequencies to low levels while sacrificing some of the performance of each of the plurality of IP blocks 110. This operation may be referred to as a throttling operation. As semiconductor processes become more miniaturized, the rate of temperature increase in each of the plurality of IP blocks 110 included in the integrated circuit 10 may gradually increase when relatively high operating frequencies are used. To address the issue, the integrated circuit 10 may detect the temperatures of the plurality of IP blocks 110 and control relatively low operating frequencies to minimize performance degradation, in order to reduce the temperature of each of the plurality of IP blocks 110. However, the timing among components included in the integrated circuit 10 may not be synchronized, and due to the time required to detect the temperature of each of the plurality of IP blocks 110, the time required to control the operating frequencies to reduce the temperature of each of the plurality of IP blocks 110, and the time required to provide the controlled operating frequencies, high operating frequencies may still be provided continuously to the plurality of IP blocks 110, so that the temperature of each of the plurality of IP blocks 110 may continuously increase. In such a case, the temperatures of the plurality of IP blocks 110 may continue to increase and may become higher than the temperatures detected at the corresponding detection time points, which may reduce the effects of the throttling operation. Accordingly, for an efficient throttling operation, a DVFS operation of managing heat generation of the IP blocks in real time by omitting a temperature detection operation and the like is required.

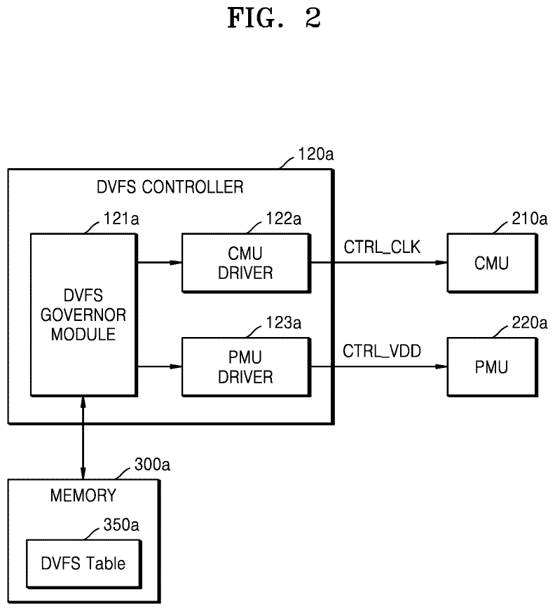

The integrated circuit 10 may perform the DVFS operation based on a pattern of an operating frequency used. For example, the integrated circuit 10 may control the operating frequencies to be used, based on the patterns of the operating frequencies previously used, in order to perform the DVFS operation, and therefore, the operation of detecting the temperature of each of the plurality of IP blocks 110 may be omitted. In this regard, detailed descriptions will be provided below with reference to FIGS. 2 to 6.

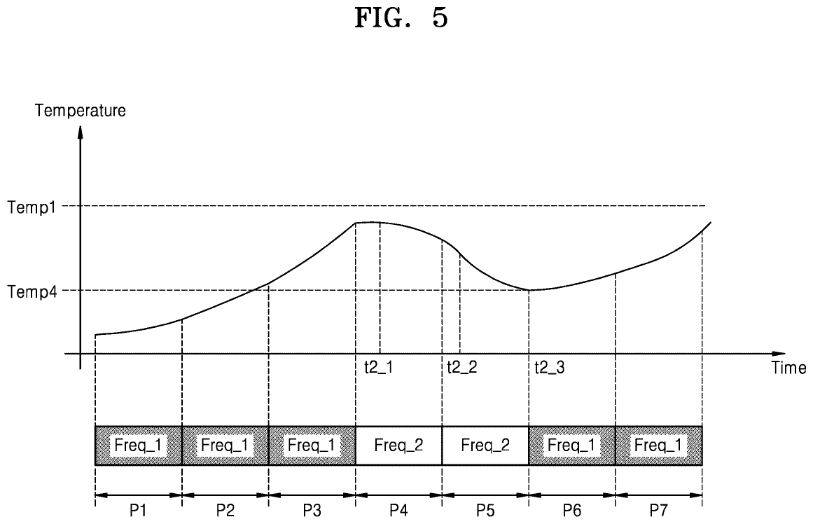

The integrated circuit 10 may perform the DVFS operation based on the pattern of the operating frequency used and a past temperature of the IP block. For example, the integrated circuit 10 according to the inventive concept may control an operating frequency to be used, based on the patterns of the operating frequencies previously used, in order to perform the DVFS operation, and may detect the past temperature of the IP block to compensate for a threshold cycle of the controlled operating frequency. That is, the integrated circuit 10 may not detect a current temperature of the IP block not to control the operating frequency to be used, but may detect the past temperature of the IP block to compensate for the threshold cycle of the controlled operating frequency while providing the controlled operating frequency to the IP block. In this regard, detailed descriptions will be provided below with reference to FIGS. 5, 7, and 8.

For convenience of description, the operating frequency previously used, which constitutes the frequency pattern, may be referred to as a pre-operating frequency. In addition, the operating frequency controlled based on the frequency pattern, that is, the operating frequency to be used to reduce the temperature of the IP block, may be referred to as a post-operating frequency.

The DVFS controller 120 may provide a clock control signal CTRL_CLK and/or a voltage control signal CTRL_VDD to the CMU 210 and/or the PMU 220 to adjust operating frequencies and/or operating voltages of each of functional blocks (e.g., the IP blocks 110), depending on operating states of several functional blocks in the integrated circuit 10.

In some implementations, the DVFS controller 120 may adjust the operating frequencies and the operating voltages provided to the plurality of IP blocks 110. The DVFS controller 120 may provide the post-operating frequencies to the plurality of IP blocks 110 to reduce the temperatures of the plurality of IP blocks 110, by controlling the CMU 210 and/or the PMU 220 based on pre-operating frequency patterns of the plurality of IP blocks 110. For example, when the pre-operating frequency pattern corresponds to a heat generation pattern (which may be referred to as a frequency pattern in the inventive concept), the DVFS controller 120 may provide a post-operating frequency to the IP block to manage the heat generation of the IP block.

The CMU 210 may generate the clock signal CLK, and may adjust a frequency of the clock signal CLK based on the clock control signal CTRL_CLK. For example, the CMU 210 may include an oscillator that generates the clock signal CLK based on the clock control signal CTRL_CLK. The CMU 210 may also be referred to as a clock generator or a clock generation circuit. The operating frequency may refer to a fundamental frequency of a system clock provided by the CMU 210 to the IP blocks or the like.

The PMU 220 may generate the supply voltage VDD, and may adjust a level of the supply voltage VDD based on the voltage control signal CTRL_VDD. In some implementations, the PMU 220 may include a switching regulator that generates the supply voltage VDD based on the voltage control signal CTRL_VDD, and may include a power management integrated circuit (PMIC).

The memory 300 may be accessed by the device 100, and the device 100 may store data in the memory 300 or read out data stored in the memory 300. The memory 300 may include a volatile memory device, such as static random access memory (SRAM) or dynamic random access memory (DRAM), and may also include a non-volatile memory device, such as flash memory or resistive random access memory (RRAM).

In some implementations, the memory 300 may store a DVFS table to be referred to by the DVFS controller 120 when performing the DVFS operation. The DVFS controller 120 may calculate a workload of tasks performed in the integrated circuit 10 and/or the plurality of IP blocks 110. The workload may refer to the amount of tasks to be processed by the IP block. The DVFS controller 120 may provide the operating frequency to the IP block according to the foregoing description in response to the calculated workload. As described above, the operating frequency may increase as the workload increases, and the temperature of the IP block may increase due to the increase in the operating frequency. The DVFS controller 120 may provide a post-operating frequency lower than a pre-operating frequency to the IP block in order to manage the heat generation of the IP block while sacrificing the performance of the IP block, when the pre-operating frequency pattern according to the workload corresponds to the heat generation pattern. The memory 300 may store the DVFS table including a heat generation pattern, which is used in the inventive concept with the same meaning as a frequency pattern. The integrated circuit 10 according to the inventive concept may refer to the DVFS table stored in the memory 300 in order to perform the DVFS operation.

The integrated circuit 10 may further include components other than the components illustrated in FIG. 1. For example, the integrated circuit 10 may further include various types of functional blocks such as an input/output (I/O) interface block, a universal serial bus (USB) host block, and a USB slave block.

FIG. 2 is a block diagram for illustrating an example of a DVFS operation according to some implementations. In FIG. 2, a DVFS controller 120a may include a DVFS governor module 121a, a CMU driver 122a, and a PMU driver 123a. Hereinafter, the term “module” may refer to hardware capable of performing functions and operations corresponding to each name, or may refer to computer program code capable of performing specific functions and operations. However, the term is not limited thereto and may also refer to a storage medium on which computer program code capable of performing specific functions and operations is stored, for example, a processor. That is, the module may refer to a functional and/or structural combination of hardware for implementing some implementations and/or software for operating the hardware.

The DVFS controller 120a, a memory 300a, a CMU 210a, and a PMU 220a in FIG. 2 respectively correspond to the DVFS controller 120, the memory 300, the CMU 210, and the PMU 220 described above with reference to FIG. 1, and repeated descriptions thereof are omitted.

The DVFS governor module 121a may control the overall DVFS operation. The DVFS governor module 121a may control the CMU driver 122a and the PMU driver 123a based on the controlled operating voltage and/or operating frequency. In some implementations, the DVFS governor module 121a may refer to a DVFS table 350a stored in the memory 300a, which includes the heat generation pattern of the IP block, and may control a post-operating frequency to be provided to the IP block, based on the DVFS table 350a. The DVFS governor module 121a may control the CMU driver 122a so that the post-operating frequency may be provided to the IP block. To this end, the DVFS governor module 121a may control the PMU driver 123a to provide a corresponding operating voltage.

The CMU driver 122a may output the clock control signal CTRL_CLK to the CMU 210a under the control by the DVFS governor module 121a. The CMU 210a may provide the clock signal CLK having the controlled post-operating frequency to the device 100 in FIG. 1 and/or the plurality of IP blocks 110 in FIG. 1 according to the clock control signal CTRL_CLK. The PMU driver 123a may output the voltage control signal CTRL_VDD to the PMU 220a under control by the DVFS governor module 121a. The PMU 220a may provide the supply voltage VDD having a magnitude determined by the voltage control signal CTRL_VDD, to the device 100 in FIG. 1 and/or the plurality of IP blocks 110 in FIG. 1.

The memory 300a may include the DVFS table 350a. The DVFS table 350a may include the heat generation pattern of each of the plurality of IP blocks 110 in FIG. 1. At least one of workload and performance may differ between each of the plurality of IP blocks 110 in FIG. 1, and accordingly, the operating frequencies may also differ from one another, and the heat generation patterns may also differ from one another. However, the present disclosure is not limited thereto. Although it has been described, with reference to FIGS. 1 and 2, that the DVFS controller 120a controls the operating frequency of each of the plurality of IP blocks 110 in FIG. 1 and that the DVFS table 350a includes the heat generation pattern of each of the plurality of IP blocks 110 in FIG. 1, this is merely for the convenience of explanation. For example, the DVFS controller 120a may control an operating frequency for one IP block, and the DVFS table 350a may include a heat generation pattern for one IP block. As described above, the heat generation pattern may be used in the same meaning as the frequency pattern, and the frequency pattern included in the DVFS table 350a may be obtained from a manufacturing stage and/or a performance test stage of the IP block. Therefore, the frequency pattern may be a predetermined pattern for the IP block.

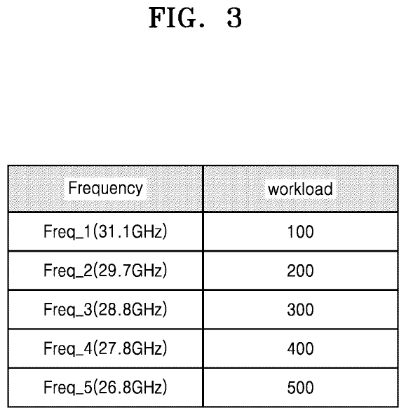

FIG. 3 is a diagram for illustrating an example of a relationship between workloads and operating frequencies according to some implementations. FIG. 3 may be understood from the above description with reference to FIGS. 1 and 2, and is provided to explain the relationship between workloads and operating frequencies for one IP block.

As described above, a high operating frequency may be required for the IP block to process a large amount of workload. In FIG. 3, when the workload is 100, the IP block may require a first operating frequency Freq_1 to process the workload. When the workload is 200, the IP block may require a second operating frequency Freq_2 to process the workload. When the workload is 300, the IP block may require a third operating frequency Freq_3 to process the workload. When the workload is 400, the IP block may require a fourth operating frequency Freq_4 to process the workload. When the workload is 500, the IP block may require a fifth operating frequency Freq_5 to process the workload. When the workload is processed based on a frequency lower than an operating frequency corresponding to the workload to be processed, the performance of the IP block may be degraded. However, the heat generation of the IP block may be lower than when the workload is processed using the operating frequency or a frequency higher than the operating frequency.

Accordingly, the DVFS controller 120 in FIG. 1 may calculate the workload of the IP block and perform an operation to provide an operating frequency corresponding to the calculated workload to the IP block in order to process the workload. When the workload increases and a high operating frequency is used to process the workload, the temperature of the IP block may increase. The integrated circuit 10 in FIG. 1 may manage heat generation of the IP block based on the operating frequency pattern.

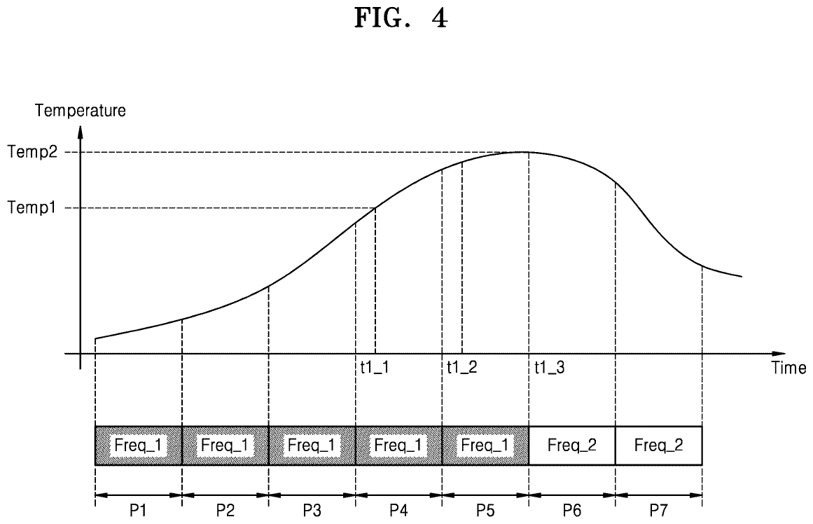

FIG. 4 is a graph illustrating examples of temperatures of an IP block according to operating frequencies according to some implementations. FIG. 4 may be understood based on the above description with reference to FIGS. 1 to 3. In the graph shown in FIG. 4, the horizontal axis represents time, and the vertical axis represents the temperature of the IP block.

In FIG. 4, each of a first period P1 to a seventh period P7 may have the same length in time. Each of the first period P1 to the seventh period P7 may have the same length as a cycle in which a DVFS controller controls an operating frequency. Although the present disclosure is not limited thereto, for the convenience of explanation, the following description is based on the assumption that each of the first period P1 to the seventh period P7 has the same length, and that the length of each of the first period P1 to the seventh period P7 is the same as a cycle in which a DVFS controller controls an operating frequency for managing heat generation of an IP block. In addition, the following description is based on the assumption that the workload of the IP block remains the same during the first period P1 to the seventh period P7.

In FIG. 4, the IP block may process the workload using the first operating frequency Freq_1 and the second operating frequency Freq_2 during the first period P1 to the seventh period P7. Specifically, the IP block may process the workload using the first operating frequency Freq_1 during the first period P1 to the fifth period P5, and may process the workload using the second operating frequency Freq_2 during the sixth period P6 to the seventh period P7. The first operating frequency Freq_1 may be higher than the second operating frequency Freq_2. As the IP block processes the workload using the first operating frequency Freq_1 that is relatively high, during the first period P1 to the fifth period P5, the temperature of the IP block may increase.

The DVFS controller may control the operating frequency used by the IP block so that the IP block operates at or below a certain temperature, hereinafter referred to as a threshold temperature. That is, the DVFS controller may perform the DVFS operation. The threshold temperature may be determined considering characteristics of a corresponding IP block, such as silicon properties, in order to extend the lifetime of the IP block or to maintain specification limits.

In FIG. 4, the threshold temperature of the IP block may be a first temperature Temp1. During the first period P1 to the third period P3, the IP block may process the workload using the first operating frequency Freq_1, and accordingly, the temperature of the IP block may increase.

As the IP block processes the workload using the first operating frequency Freq_1, the temperature of the IP block may increase, and at a first time point t1_1 included in the fourth period P4, the temperature of the IP block may reach Temp1, which is a threshold temperature. The temperature of the IP block may be detected by a temperature sensor that may be included inside or outside the IP block. The temperature sensor may be configured to transmit the detected temperature information to the DVFS controller. The DVFS controller may lower the operating frequency to lower the temperature of the IP block based on the received temperature information. However, as described above, the length of each of the first period P1 to the seventh period P7 may be the same, and the length of each of the first period P1 to the seventh period P7 may be the same as the period for which the DVFS controller controls the operating frequency. Accordingly, even though the temperature of the IP block has reached the first temperature Temp1, which is the threshold temperature, at the first time point t1_1, the IP block may process the workload using the first operating frequency Freq_1 in the fourth period P4 that includes the first time point t1_1. Due to this, the temperature of the IP block in the fourth period P4 may continuously rise.

As described above, a time difference may occur between the time point at which the temperature of the IP block is detected and the time point at which a post-operating frequency is provided, due to the time required to detect the temperature of the IP block, the time required to control the operating frequency for lowering the temperature of the IP block, and the time required to provide the controlled operating frequency. Additionally, components related to the DVFS operation, such as the DVFS controller, temperature sensor, and CMU, may not be time synchronized with one another, which may further increase the time difference between the time point at which the temperature is detected and the time point at which the post-operating frequency is provided. For example, due to the aforementioned causes, a time difference between a point in time at which temperature is detected and a point in time at which a post-operating frequency is provided may be equal to or longer than a period during which a DVFS controller controls an operating frequency. In FIG. 4, a difference between a second time point t1_2 and the first time point t1_1 at which the first temperature Temp1 is detected may be equal to or greater than a cycle during which the DVFS controller controls an operating frequency. In other words, a difference between the second time point t1_2 and the first time point t1_1 at which the first temperature Temp1 is detected may be equal to or greater than a length of each of the first period P1 to the seventh period P7. Accordingly, although the temperature of the IP block reaches the first temperature Temp1 at the first time point t1_1, the first operating frequency Freq_1 may be provided to the IP block in the fifth period P5, so that the temperature of the IP block may continuously increase until a third time point t1_3 at which the fifth period P5 ends. In FIG. 4, the temperature of the IP block may increase up to a second temperature Temp2.

Thereafter, the DVFS controller may perform the DVFS operation based on the first temperature Temp1 detected at the first time point t1_1, and may control a frequency used by the IP block to the second operating frequency Freq_2. As the IP block processes the workload by using the second operating frequency Freq_2, that is, the post-operating frequency, the temperature of the IP block may decrease.

However, as described above with reference to FIG. 4, due to causes, such as latency caused by temperature sensing and controlling of the post-operating frequency, the DVFS controller may fail to immediately perform the DVFS operation at the first time point t1_1 at which the first temperature Temp1 is reached. Accordingly, at a point in time when the post-operating frequency is applied to the IP block, the temperature of the IP block may reach the second temperature Temp2, which is higher than the first temperature Temp1, thereby causing a reduction in a throttling effect resulting from the DVFS operation.

FIG. 5 is a graph illustrating an example of a DVFS operation according to some implementations. FIG. 5 may be compared with FIG. 4, and may be understood through the above description with reference to FIGS. 1 to 3.

In the graph shown in FIG. 5, the horizontal axis represents time, and the vertical axis represents temperature of the IP block. It is assumed below that the IP block in FIG. 4 is the same as the IP block in FIG. 5. Accordingly, it is assumed below that the IP block in FIG. 4 and the IP block in FIG. 5 may reach the threshold temperature based on the same pattern of the operating frequency. In addition, the following description is based on the assumption that the workload of the IP block remains the same during the first period P1 to the seventh period P7.

In FIG. 5, lengths of the first period P1 to the seventh period P7 may be the same. Each of the first period P1 to the seventh period P7 may have the same length as a cycle in which the DVFS controller controls the operating frequency. Although the present disclosure is not limited thereto, for the convenience of explanation, the following description is based on the assumption that each of the first period P1 to the seventh period P7 has the same length, and that the length of each of the first period P1 to the seventh period P7 is the same as a cycle in which the DVFS controller controls the operating frequency for managing heat generation of the IP block.

In FIG. 5, the IP block may process the workload by using the first operating frequency Freq_1 and the second operating frequency Freq_2 during the first period P1 to the seventh period P7. Specifically, the IP block may process the workload using the first operating frequency Freq_1 in the first period P1 to the third period P3, using the second operating frequency Freq_2 in the fourth period P4 to the fifth period P5, and using the first operating frequency Freq_1 again in the sixth period P6 to the seventh period P7. The first operating frequency Freq_1 may be higher than the second operating frequency Freq_2. As the IP block processes the workload by using the first operating frequency Freq_1 that is relatively high, during the first period P1 to the third period P3, the temperature of the IP block may increase.

In FIG. 4, if the first operating frequency Freq_1 is applied in the first period P1 to the third period P3 and is also applied to the operation of the IP block in the fourth period P4, the temperature of the IP block may reach the threshold temperature. Accordingly, the integrated circuit 10 in FIG. 1 may control an operating frequency lower than the first operating frequency Freq_1 as the post-operating frequency in the fourth period P4, based on a pattern of the operating frequency applied in the first period P1 to the third period P3 (for example, the pattern in which the first operating frequency Freq_1 is applied three times consecutively), that is, the heat generation pattern. For example, in FIG. 5, the integrated circuit 10 in FIG. 1 may process the workload by using the second operating frequency Freq_2, which is lower than the first operating frequency Freq_1, in the fourth period P4. The integrated circuit 10 in FIG. 1 may manage heat generation of the IP block so that the temperature of the IP block does not reach the threshold temperature, by causing the IP block to process the workload by using the second operating frequency Freq_2 in the fourth period P4.

The first time point t1_1, the second time point t1_2, and the third time point t1_3 in FIG. 4 may correspond to a first time point t2_1, a second time point t2_2, and a third time point t2_3 in FIG. 5, respectively. When FIGS. 4 and 5 are compared, in the case where the integrated circuit 10 performs the DVFS operation based on the temperature sensing of the IP block (i.e., in FIG. 4), the temperature of the IP block may reach the threshold temperature at the first time point t1_1 in FIG. 4 due to the above-described delay, such as the time required for the temperature sensing. In contrast, in the case where the integrated circuit 10 performs the DVFS operation based on a pattern of the previously used operating frequency, that is, the heat generation pattern (i.e., in the case of FIG. 5), the integrated circuit 10 in FIG. 1 may manage heat generation of the IP block so that the temperature of the IP block does not reach the threshold temperature.

In FIG. 5, the integrated circuit 10 in FIG. 1 may provide the second operating frequency Freq_2 to the IP block in the fourth period P4 and the fifth period P5 for managing the heat generation of the IP block. Accordingly, the temperature of the IP block may decrease, and the temperature of the IP block may reach a fourth temperature Temp4. As the relatively low second operating frequency Freq_2 is provided to the IP block in the fourth period P4 and the fifth period P5, the integrated circuit 10 in FIG. 1 may determine that a sufficient temperature margin (for example, a difference between the first temperature Temp1 and the fourth temperature Temp4) has been secured. In the sixth period P6 to the seventh period P7, the integrated circuit 10 in FIG. 1 may provide the first operating frequency Freq_1 that is relatively high, to the IP block, considering the temperature margin, workload, and the like.

The number of periods shown in FIGS. 4 and 5, the operating frequency provided to the IP block in each period, and the temperature of the IP block resulting from the provided operating frequency are merely examples to aid in understanding the present disclosure, and the present disclosure is not limited thereto.

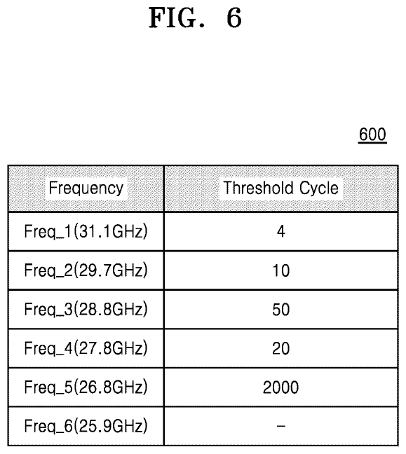

FIG. 6 is a diagram for illustrating an example of a DVFS table according to some implementations. FIG. 6 may be described below with reference to FIGS. 2, 4, and 5. Additionally, descriptions that overlap with the above-described explanation may be omitted. FIG. 6 is described below based on the above-described implementations with reference to FIGS. 4 and 5. However, this is merely for the understanding of the present disclosure and the present disclosure is not limited thereto.

FIG. 6 shows a DVFS table 600 indicating threshold cycles corresponding to operating frequencies available to the IP block. As described above with reference to FIG. 2, the DVFS table 600 may include a heat generation pattern of an IP block, and the DVFS table 600 may be stored in the memory 300a in FIG. 2.

In FIGS. 4 and 5, when the first operating frequency Freq_1 is continuously provided to the IP block in four periods, the temperature of the IP block may reach the threshold temperature Temp1 in FIG. 5. Accordingly, a threshold cycle corresponding to the first operating frequency Freq_1 may be 4. Here, the threshold cycle may be understood as the number of periods in which a specific operating frequency is provided until the temperature of the IP block reaches the threshold temperature. Accordingly, as described above with reference to FIG. 5, the integrated circuit 10 in FIG. 1 may manage the heat generation of the IP block by providing the second operating frequency Freq_2 to the IP block in the fourth period P4 in FIG. 5, based on the DVFS table 600, so that the temperature of the IP block does not reach the threshold temperature Temp1.

In FIG. 6, the operating frequencies decrease from the first operating frequency Freq_1 to the sixth operating frequency Freq_6. Referring to the above description, a threshold cycle corresponding to the second operating frequency Freq_2 may be 10, a threshold cycle corresponding to the third operating frequency Freq_3 may be 50, a threshold cycle corresponding to the fourth operating frequency Freq_4 may be 200, and a threshold cycle corresponding to the fifth operating frequency Freq_5 may be 2,000. When the sixth operating frequency Freq_6 which is the lowest is provided to the IP block, the temperature of the IP block may not reach a threshold temperature.

The example described above with reference to FIG. 6, that is, the operating frequency provided to the IP block, the number of operating frequencies, and the threshold cycle corresponding to the operating frequency, are merely for the understanding of the DVFS table according to the present disclosure, and the present disclosure is not limited thereto.

In FIG. 6, the DVFS table may include threshold cycles corresponding to operating frequencies previously provided to the IP block and the number of times the operating frequencies were provided. For example, if the first operating frequency Freq_1, which is the highest frequency, is provided to the IP block n times (n is an integer greater than or equal to 1), the threshold cycle corresponding to the second operating frequency Freq_2 lower than the first operating frequency Freq_1 may be m (m is an integer greater than or equal to 1), and the threshold cycle corresponding to the third operating frequency Freq_3 lower than the second operating frequency Freq_2 may be k (k is an integer greater than or equal to m). Since the temperature of the IP block is related to the previously provided operating frequency, the temperature of the IP block according to a first scenario in which the first operating frequency Freq_1 was previously provided three times may be lower than the temperature of the IP block according to a second scenario in which the first operating frequency Freq_1 was previously provided five times. Accordingly, in the first scenario, the integrated circuit 10 in FIG. 1 may control the second operating frequency Freq_2 as the post-operating frequency, and in the second scenario, the integrated circuit 10 in FIG. 1 may control the third operating frequency Freq_3 as the post-operating frequency to further lower the temperature of the IP block. The above-described example is merely for the understanding of the present disclosure, and the present disclosure is not limited thereto. The integrated circuit 10 in FIG. 1 may determine the post-operating frequency based on a pattern of previously provided operating frequencies (for example, the number of times in which the first operating frequency Freq_1 and/or the second operating frequency Freq_2 have been provided, and the like) and the DVFS table according to the inventive concept may include the post-operating frequency and a threshold cycle corresponding to the post-operating frequency according to the above-described content. The integrated circuit 10 in FIG. 1 may manage the heat generation of the IP block by referring to the DVFS table.

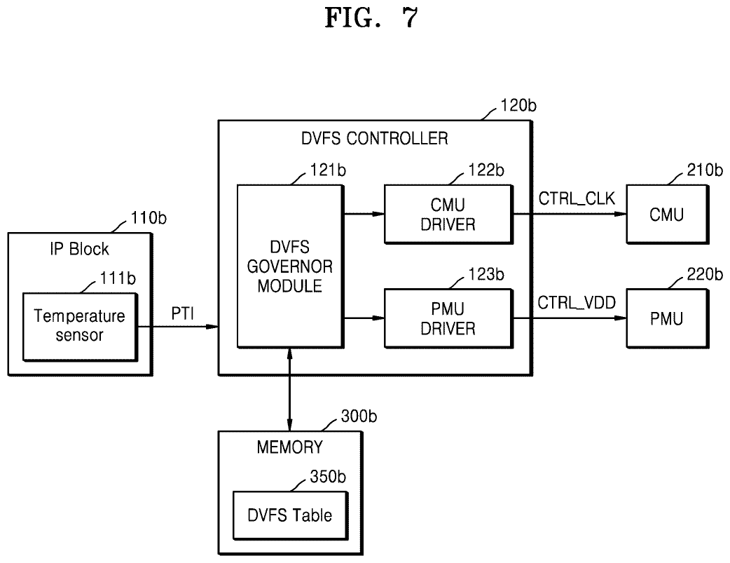

FIG. 7 is a block diagram for illustrating an example of a DVFS operation according to some implementations. In FIG. 7, a DVFS controller 120b may include a DVFS governor module 121b, a CMU driver 122b, and a PMU driver 123b. The DVFS governor module 121b, the CMU driver 122b, and the PMU driver 123b in FIG. 7 may correspond to the DVFS governor module 121a, the CMU driver 122a, and the PMU driver 123a, respectively, as described above with reference to FIG. 2, and redundant description thereof is omitted.

Additionally, the DVFS controller 120b, a memory 300b, a CMU 210b, and a PMU 220b in FIG. 7 may respectively correspond to the DVFS controller 120, the memory 300, the CMU 210, and the PMU 220 described above with reference to FIG. 1, and redundant description thereof is omitted.

The DVFS controller 120b may receive past temperature information PTI from the IP block 110b. Specifically, the IP block 110b may be configured to include a temperature sensor 111b. The temperature sensor 111b may measure an internal temperature of the IP block 110b to generate the past temperature information PTI of the IP block 110b. The past temperature information PTI is described in detail below. The IP block 110b may be one of the plurality of IP blocks 110 described above with reference to FIG. 1. Additionally, the integrated circuit 10 in FIG. 1 may further include a temperature management unit (TMU). The TMU may receive the past temperature information PTI from the IP block 110b and transmit the past temperature information PTI to the DVFS controller 120b.

As described above, the DVFS operation of detecting a current temperature of the IP block 110b and controlling the operating frequency according to the current temperature may cause delay. The temperature of the IP block 110b may not be managed below a limit temperature due to the delay.

The DVFS controller 120b may control the operating frequency by considering the pattern of the operating frequencies included in a DVFS table 350b and provide the controlled operating frequency to the IP block 110b. The operation of controlling the operating frequency by considering the heat generation pattern has been described above with reference to FIGS. 5 and 6.

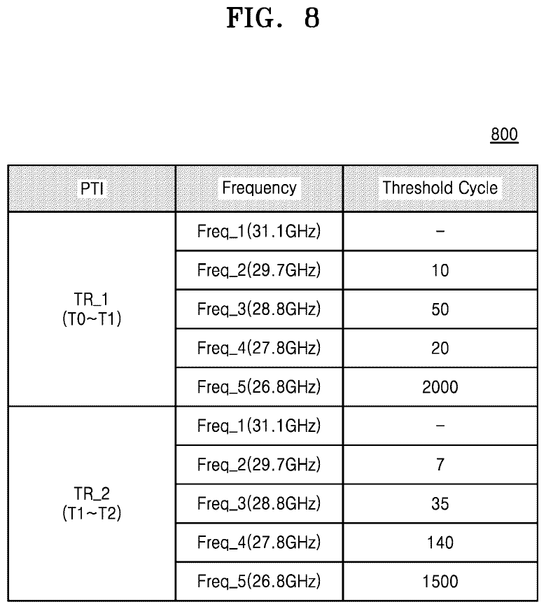

The DVFS controller 120b may control the operating frequency by considering the heat generation pattern. Additionally, the DVFS controller 120b may receive temperature information of the IP block 110b at a time point at which the operating frequency is controlled or at a time point near that time point (or referred to as a time point at which a frequency provided to the IP block 110b changes from a pre-operating frequency to a post-operating frequency, or a time point near that time point). After controlling the operating frequency to manage the temperature of the IP block 110b, the DVFS controller 120b may receive the temperature information of the IP block 110b at or near the time at which the operating frequency is controlled. Accordingly, the temperature information according to the present disclosure is referred to as the past temperature information PTI. The DVFS controller 120b may complement a threshold cycle of a post-operating frequency included in the DVFS table 350b, based on the past temperature information PTI. The DVFS table 350b according to some implementations may include a threshold cycle according to the past temperature information PTI. In this regard, more detailed description is provided below with reference to FIG. 8.

FIG. 8 is a diagram for illustrating an example of a DVFS table according to some implementations. In FIG. 8, a DVFS table 800 may correspond to the DVFS table 350b described above with reference to FIG. 7.

As described above with reference to FIG. 7, the DVFS controller 120b in FIG. 7 may determine an operating frequency and a threshold cycle of the operating frequency by referring to the DVFS table 800 and the past temperature information PTI.

The example described below may be understood by referring to FIG. 5. For example, the temperature of the IP block that processes a workload using the previously provided first operating frequency Freq_1 in three periods P1, P2, and P3 in FIG. 5 may be 100° C., which may be near a threshold temperature and lower than the threshold temperature. The DVFS controller 120b in FIG. 7 may infer, based on a heat generation pattern included in the DVFS table (e.g., 600 in FIG. 6), that the temperature of the IP block will reach a threshold temperature, and may control the second operating frequency Freq_2 as an operating frequency without delay due to the temperature sensing, and provide the second operating frequency Freq_2 to the IP block in two periods P4 and P5 in FIG. 5. Referring to FIG. 5, when the second operating frequency Freq_2 is provided to the IP block in two periods P4 and P5 in FIG. 5, the DVFS controller 120b in FIG. 7 may infer, based on the heat generation pattern according to the DVFS table, that the temperature of the IP block is the fourth temperature Temp4 in FIG. 5.

However, depending on other IP blocks located around the IP block or the usage environment, the actual temperature of the IP block may not match the heat generation pattern according to the DVFS table. Accordingly, the DVFS controller 120b in FIG. 7 may sense the temperature of the IP block simultaneously with or after controlling the operating frequency for temperature management of the IP block. Due to the time required for sensing the temperature of the IP block and the lack of start-up synchronization between components, the DVFS controller 120b in FIG. 7 may receive the temperature information of the IP block, which is detected after the time point at which the controlled operating frequency is provided to the IP block, that is, the past temperature information PTI. The DVFS controller 120b in FIG. 7 may determine an appropriate operating frequency and/or the threshold cycle for the IP block based on the past temperature information PTI.

For example, as described above, when the second operating frequency Freq_2 is provided to the IP block in two periods P4 and P5 in FIG. 5, the DVFS controller 120b in FIG. 7 may infer, based on the heat generation pattern according to the DVFS table, that the temperature of the IP block is the fourth temperature Temp4 in FIG. 5.

In the DVFS table 800, in FIG. 8, a first temperature range TR_1 may range from T0 to T1, and a second temperature range TR_2 may range from T1 to T2. The second temperature range TR_2 may be a temperature range higher than the first temperature range TR_1. The DVFS controller 120b in FIG. 7 may determine a temperature range to which the past temperature information PTI belongs, and may determine the operating frequency and the threshold cycle of the operating frequency according to the temperature range to which the past temperature information PTI belongs. For example, the temperature of the IP block according to the past temperature information PTI may be the fourth temperature Temp4 in FIG. 5, or may be near the fourth temperature Temp4, and may belong to the first temperature range TR_1. Accordingly, the DVFS controller 120b in FIG. 7 may control an operating frequency to the first operating frequency Freq_1 in the sixth period P6 and the seventh period P7 in FIG. 5 according to the corresponding heat generation pattern, and provide the first operating frequency Freq_1 to the IP block.

On the other hand, as described above, the actual temperature of the IP block may not match the heat generation pattern according to the DVFS table depending on other IP blocks located around the IP block or operating environments. That is, the temperature according to the past temperature information PTI may be higher than the fourth temperature Temp4 in FIG. 5, and may belong to the second temperature range TR_2. When the past temperature information PTI belongs to the second temperature range TR_2, the threshold cycle corresponding to each of the second operating frequency Freq_2 to the fifth operating frequency Freq_5 may be smaller than that in the case where the past temperature information PTI belongs to the first temperature range TR_1. Accordingly, the DVFS controller 120b may manage heat generation of the IP block by controlling an operating frequency without delay based on a heat generation pattern, and may more accurately manage the heat generation of the IP block without delay by reflecting effects of actual environments based on the past temperature information PTI.

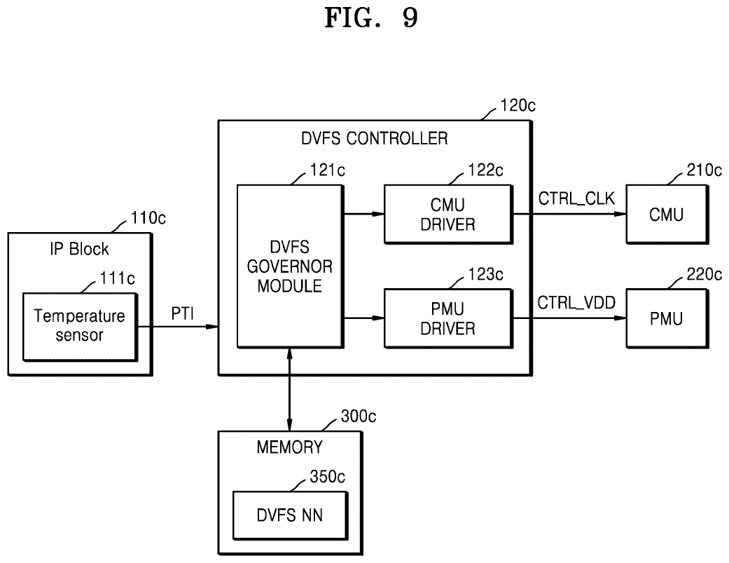

FIG. 9 is a block diagram for illustrating an example of a DVFS operation according to some implementations. In FIG. 9, a DVFS controller 120c may include a DVFS governor module 121c, a CMU driver 122c, and a PMU driver 123c. The DVFS governor module 121c, the CMU driver 122c, and the PMU driver 123c in FIG. 9 may correspond to the DVFS governor module 121a, the CMU driver 122a, and the PMU driver 123a, respectively, as described above with reference to FIG. 2, and redundant description thereof is omitted. Additionally, the DVFS controller 120c, a memory 300c, a CMU 210c, and a PMU 220c in FIG. 9 may correspond to the DVFS controller 120, the memory 300, the CMU 210, and the PMU 220 described above with reference to FIG. 1, and redundant description thereof is omitted. In addition, an IP block 110c in FIG. 9, a temperature sensor 111c included in the IP block 110c, and the past temperature information PTI correspond to the IP block 110b, the IP block 110b and the past temperature information PTI described above with reference to FIG. 7, respectively, and any overlapping description thereof will be omitted. The IP block 110c may be one of the plurality of IP blocks 110 described above with reference to FIG. 1. As the above-described, the integrated circuit 10 in FIG. 1 may further include the TMU. The TMU may receive the past temperature information PTI from the IP block 110c and transmit the to the DVFS controller 120c.

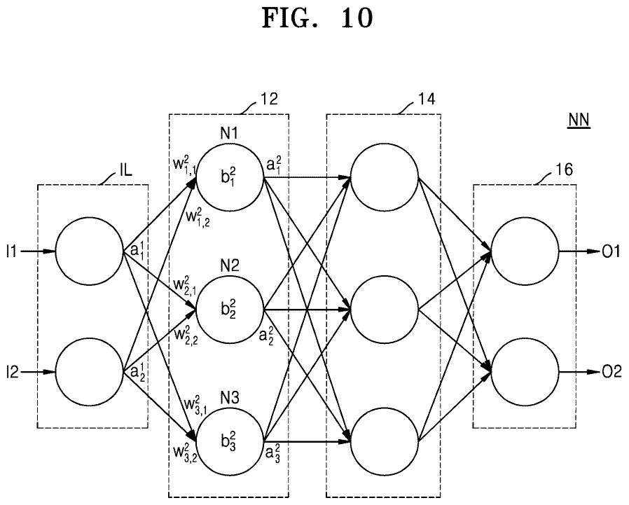

In FIG. 9, the memory 300c may store a DVFS neural network 350c. The integrated circuit 10 in FIG. 1 may manage the heat generation of the IP block by learning the frequency pattern based on the DVFS neural network. More details about the DVFS neural network are described later with reference to FIG. 10.

FIG. 10 is a diagram illustrating an example of a DVFS neural network according to some implementations. In FIG. 10, a neural network NN is merely for understanding a DVFS neural network structure (or a DVFS neural network model structure) according to the present disclosure, and the present disclosure is not limited thereto.

In FIG. 10, the neural network NN may have a structure including an input layer, one or more hidden layers, and an output layer. The neural network NN may perform operations based on received input data I1 and I2 and generate output data O1 and O2 based on the results of the operations. The input data I1 and I2 of the neural network NN according to some implementations may be the frequency patterns and temperatures corresponding to the frequency patterns. The neural network NN may generate the output data O1 and O2 based on the input data I1 and I2, which are the frequency pattern and the temperature corresponding to the frequency pattern. For example, the output data O1 and O2 may be the post-operating frequency and the threshold cycle of the post-operating frequency.

The neural network NN may further receive the past temperature information PTI as input data. The neural network NN may complement the threshold cycle of the post-operating frequency by reflecting the influence of the operating environment on the IP block based on the past temperature information PTI.

The neural network NN may be a deep neural network (DNN) including two or more hidden layers, or an n-layer neural network. For example, the neural network NN may be the DNN including an input layer IL, first and second hidden layers 12 and 14, and an output layer 16. A plurality of layers may include a convolutional layer, a fully-connected layer, a softmax layer, and the like, each having a different structure. For example, a convolutional layer may include operations such as convolution, pooling, activation functions, or the like. In some implementations, convolution, pooling, and activation function operations may each be implemented as separate layers. However, a model for the neural network according to the present disclosure is not limited thereto.

Outputs of a plurality of layers IL, 12, 14, and 16 may be referred to as features or feature maps. Each of the plurality of layers IL, 12, 14, and 16 may receive a feature generated by a previous layer as an input feature, and may generate an output feature or output signal by processing the input feature. The feature may refer to data representing various characteristics of input data recognizable by the neural network NN.

When the neural network NN has the DNN structure, the neural network NN may include more layers capable of extracting effective information, and thus may process complex data sets. Although the neural network NN is illustrated as including four layers IL, 12, 14, and 16, this is merely an example, and the neural network NN may include fewer or more layers. In addition, the neural network NN may include layers having various structures different from those illustrated in FIG. 5.

Each of the plurality of layers IL, 12, 14, and 16 included in the neural network NN may include a plurality of neurons. Neurons may correspond to a plurality of artificial nodes, which are also referred to as units or similar terms. For example, as illustrated in FIG. 10, the input layer IL may include two neurons (nodes), and each of the first and second hidden layers 12 and 14 may include three neurons (nodes). However, this is merely an example, and each layer included in the neural network NN may include a different number of neurons (nodes).

The neurons included in each of the plurality of layers IL, 12, 14, and 16 of the neural network NN may be interconnected to exchange data. One neuron may receive data from other neurons and perform computation, and may output a result to other neurons.

An input and an output of each neuron (node), for example, N1, N2, and N3, may be referred to as an input activation and an output activation, respectively. That is, an activation may be an output of one neuron and at the same time a parameter that serves as an input to neurons included in a next layer. In addition, each of the neurons may determine its own output activation based on the output activations received from the neurons included in the previous layer

$$( e . g . , {a}_{1}^{1} , {a}_{2}^{1} , {a}_{1}^{2} , {a}_{2}^{2} , {a}_{3}^{2} ,$$

etc.), weights (e.g.,

$${w}_{1 , 1}^{2} , {w}_{1 , 2}^{2} , {w}_{2 , 1}^{2} , {w}_{2 , 2}^{2} , {w}_{3 , 1}^{2} , {w}_{3 , 2}^{2} ,$$

etc.) and biases (e.g.,

$${b}_{1}^{2} , {b}_{2}^{2} , {b}_{3}^{2} ,$$

etc.). Weights and biases may be parameters used to compute an output activation in each neuron and may be referred to as weight parameters. Specifically, a weight may be a value assigned to a connection between neurons, and a bias may represent a coefficient associated with an individual neuron. The neural network NN may determine parameters such as weights and biases so that a loss value generated by a loss function is minimized. The determined parameters may be stored in the memory 300c of FIG. 9.

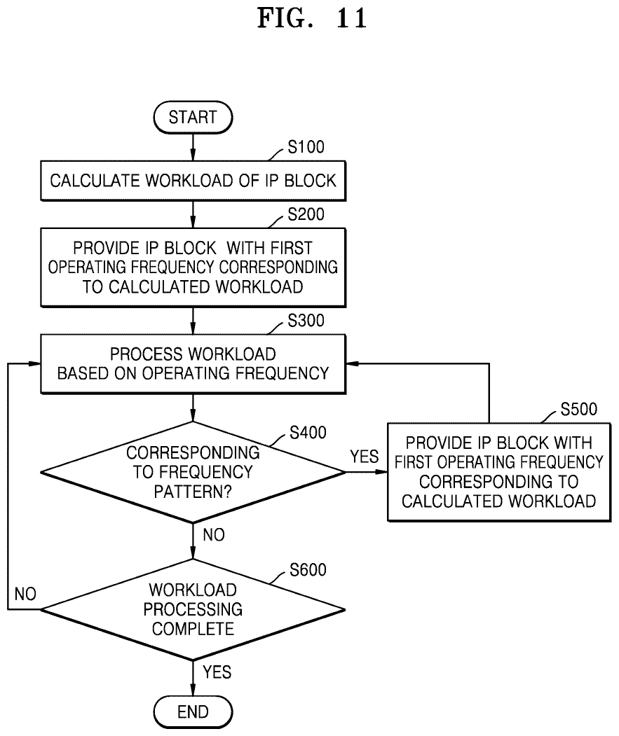

FIG. 11 is a flowchart illustrating an example of an operating method of an integrated circuit according to some implementations. In FIG. 11, in operation S100, the integrated circuit may calculate a workload of an IP block.

In operation S200, the integrated circuit may provide a first operating frequency corresponding to the calculated workload to the IP block.

In operation S300, the integrated circuit may process the workload based on the first operating frequency. Specifically, the IP block may process the workload based on an operating frequency. For example, the operating frequency may be the first operating frequency determined based on the calculated workload.

In operation S400, the integrated circuit may determine whether at least one operating frequency provided to the IP block and a cycle in which the operating frequency has been provided correspond to a frequency pattern. For example, as described above with reference to FIG. 5, when the first operating frequency Freq_1 is provided to the IP block for three consecutive cycles, the integrated circuit may determine that the frequency and the cycle correspond to the frequency pattern.

In operation S500, the integrated circuit may provide a second operating frequency to the IP block based on the determination of the correspondence to the frequency pattern. In some implementations, the integrated circuit may omit sensing the temperature of the IP block and provide the second operating frequency to the IP block. Here, since the integrated circuit provides the second operating frequency to the IP block in order to lower the temperature of the IP block, the second operating frequency may be lower than the first operating frequency.

In operation S600, the integrated circuit may determine whether a workload has been processed based on a determination that the frequency and the cycle do not correspond to the frequency pattern. If the workload has been processed, then the operation may be terminated; however, if the workload has not been processed, then the integrated circuit may repeatedly perform processing of the workload and determination of whether the frequency and the cycle correspond to the frequency pattern, based on the first operating frequency, until the workload is completed.

The operating method of the integrated circuit may further include generating the past temperature information of the IP block by sensing the temperature of the IP block. The integrated circuit may perform the generating operation of the past temperature information when the integrated circuit, in the determining operation, determines that the frequency and the cycle correspond to the frequency pattern.

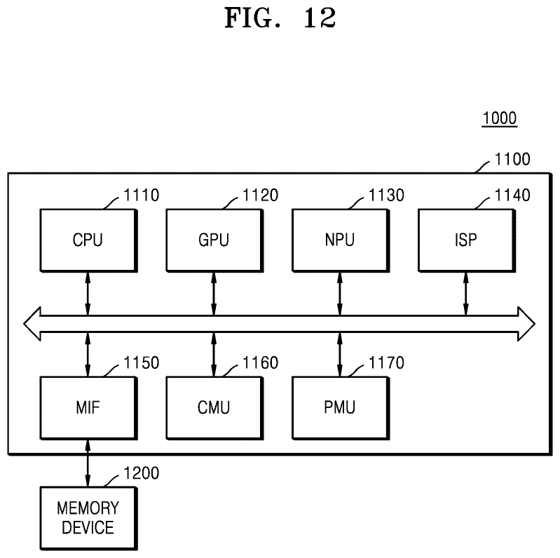

FIG. 12 is a block diagram illustrating an example of a system according to some implementations. In FIG. 12, a system 1000 may be implemented as a handheld device, such as a mobile phone, a smartphone, a tablet computer, a personal digital assistant (PDA), an enterprise digital assistant (EDA), a digital still camera, a digital video camera, a portable multimedia player (PMP), a personal or portable navigation device (PDN), a handheld game console, or an e-book.

The system 1000 may include a system on chip (SoC) 1100 and a memory device 1200. The SoC 1100 may include a CPU 1110, a GPU 1120, an NPU 1130, an ISP 1140, a memory interface (MIF) 1150, a CMU 1160, or a PMU 1170. The CPU 1110, the GPU 1120, the NPU 1130, and the ISP 1140 may be referred to as IP blocks. At least one of the CPU 1110, the GPU 1120, the NPU 1130, and the ISP 1140 may be an implementation example of the device 100 or the plurality of IP blocks 110 described with reference to FIGS. 1 to 11. Accordingly, at least one of the CPU 1110, the GPU 1120, the NPU 1130, and the ISP 1140 may include the DVFS controller that performs the DVFS operation according to some implementations. The DVFS controller included in the CPU 1110, the GPU 1120, the NPU 1130, or the ISP 1140 may control the CMU 1160 or the PMU 1170. The CPU 1110, the GPU 1120, the NPU 1130, and the ISP 1140 may process instructions by receiving the clock signal CLK from the CMU 1160 and a power supply voltage from the PMU 1170. The DVFS controller included in the CPU 1110, the GPU 1120, the NPU 1130, or the ISP 1140 may manage the heat generation of the IP block and improve the performance of the device or the IP block by omitting the operation of sensing a temperature of the IP block and performing the DVFS operation, by providing the operating frequency according to power characteristics, based on the frequency pattern provided to the IP block.

The CPU 1110 may process or execute the workload corresponding to instructions and/or data stored in the memory device 1200 in response to the clock signal generated by the CMU 1160, that is, based on the operating frequency controlled by the DVFS controller.

The GPU 1120 may acquire image data stored in the memory device 1200 in response to the clock signal generated by the CMU 1160, that is, based on the operating frequency controlled by the DVFS controller. The GPU 1120 may generate data for an image to be output on a display device from image data provided by the MIF 1150, or may encode the image data.

The NPU 1130 may refer to a device configured to execute a machine learning model. The NPU 1130 may be a hardware block designed to execute the machine learning model. The machine learning model may be based on an artificial neural network (ANN), a decision tree, a support vector machine (SVM), regression analysis, a Bayesian network, a genetic algorithm, or the like. The artificial neural network may include, as non-limiting examples, a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network (FCN), a long short-term memory (LSTM) network, or a classification network.

The ISP 1140 may perform signal processing on raw data received from an image sensor located outside the SoC 1100, and may generate digital data having enhanced image quality.

The MIF 1150 may provide an interface to the memory device 1200 located outside the SoC 1100. The memory device 1200 may be DRAM, PRAM, RRAM, or flash memory.

The CMU 1160 may generate the clock signal and provide the clock signal to components of the SoC 1100. The CMU 1160 may include a clock generation device, such as a phase-locked loop (PLL), a delayed-locked loop (DLL), or a crystal. The PMU 1170 may convert an external power supply into an internal power supply and may supply power to components of the SoC 1100.

The IP block that may be included in the system 1000 is not limited to the examples described above with reference to FIG. 12, and operations of the IP blocks are not limited thereto.

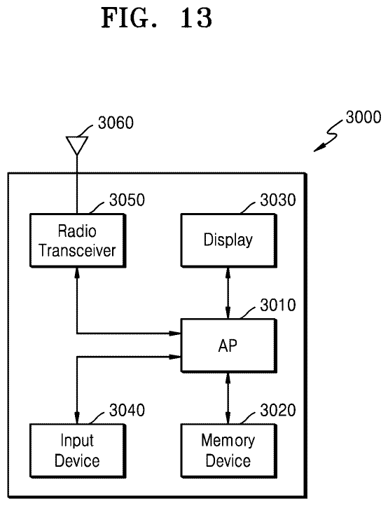

FIG. 13 is a block diagram illustrating an example of an electronic device including an AP according to some implementations. In FIG. 13, a communication device 3000 may include an AP 3010, a memory device 3020, a display 3030, an input device 3040, and a wireless transceiver 3050. The AP 3010 may be an implementation example of the integrated circuit 10 described with reference to FIGS. 1 to 11.

The wireless transceiver 3050 may wirelessly transmit or receive radio frequency (RF) signals through the antenna 3060. For example, the wireless transceiver 3050 may convert the signals received through the antenna 3060 into a signal that may be processed by the AP 3010.

Accordingly, the AP 3010 may process a signal output from the wireless transceiver 3050 and may transmit the processed signal to the display 3030. In addition, the wireless transceiver 3050 may convert a signal output from the AP 3010 into converted signals and may output the converted signals to an external device through the antenna 3060.

The input device 3040 may be a device configured to input a control signal for controlling operations of the AP 3010 or data to be processed by the AP 3010, and may be implemented as a pointing device, such as a touch pad or a computer mouse, a keypad, or a keyboard.

In some implementations, the AP 3010 may include the DVFS controller 120 according to some implementations. As described with reference to FIGS. 1 to 11, the DVFS controller 120 may control the operating frequency to be provided to each of the IP blocks, based on the DVFS table 350 including the patterns of operating frequencies provided to the IP blocks, in order to manage the heat generation of each of the IP blocks. The DVFS controller 120 may manage the heat generation of each of the IP blocks by changing and providing the operating frequency at an earlier time point than when the frequency is changed, based on temperature sensing of the IP block, thereby efficiently performing throttling and improving the performance of the AP 3010.

In FIG. 13, the communication device 3000 may further include a CMU that provides the clock signal to various components and a PMU that supplies a power supply voltage. The CMU may output the clock signal having an adjusted frequency under control by the DVFS controller 120, and the PMU may output the power supply voltage having an adjusted magnitude under control by the DVFS controller 120.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. An integrated circuit comprising:
an intellectual property (IP) block; and
a dynamic voltage and frequency scaling (DVFS) controller configured to calculate a workload of the IP block and control an operating frequency provided to the IP block to process the workload,
wherein the DVFS controller is configured to:
determine a post-operating frequency based on at least one pre-operating frequency provided to the IP block and at least one frequency pattern corresponding to a number of cycles during which the at least one pre-operating frequency is provided to the IP block; and
provide the post-operating frequency to the IP block based on the at least one frequency pattern, during a number of cycles equal to or less than a threshold cycle corresponding to the post-operating frequency.

2. The integrated circuit of claim 1, wherein the DVFS controller is configured to determine the post-operating frequency based on omitting a temperature sensing operation for the IP block.

3. The integrated circuit of claim 1, wherein the post-operating frequency comprises a frequency lower than the at least one pre-operating frequency.

4. The integrated circuit of claim 1, comprising a memory device configured to store a DVFS table that includes the at least one pre-operating frequency and the at least one frequency pattern corresponding to the number of cycles of the IP block having been provided with the at least one pre-operating frequency.

5. The integrated circuit of claim 1, wherein the DVFS controller is configured to, after determining the post-operating frequency, receive past temperature information comprising temperature information for the IP block.

6. The integrated circuit of claim 5, wherein the past temperature information comprises the temperature information of the IP block before the post-operating frequency is provided to the IP block.

7. The integrated circuit of claim 5, comprising a memory device configured to store a DVFS table that includes the at least one pre-operating frequency and the at least one frequency pattern corresponding to the number of cycles of the IP block having been provided with the at least one pre-operating frequency,
wherein the DVFS controller is configured to:
determine a first frequency pattern corresponding to a temperature range in which a temperature of the IP block, according to the past temperature information, is reduced;
determine a first frequency included in the first frequency pattern as the post-operating frequency; and
provide the first frequency to the IP block during the number of cycle equal to or less than a first threshold cycle corresponding to the first frequency.

8. The integrated circuit of claim 1, comprising a memory device configured to:
store parameters of a DVFS neural network;
receive, as input data, the at least one pre-operating frequency and the number of cycles of the IP block having been provided with the at least one pre-operating frequency; and
perform training based on the input data, and output, as output data, the post-operating frequency and the threshold cycle corresponding to the post-operating frequency.

9. An operating method of an integrated circuit, the method comprising:
calculating a workload of an intellectual property (IP) block;
providing a first operating frequency to the IP block corresponding to the calculated workload;
processing the workload based on the first operating frequency;
determining a correspondence of (i) at least one operating frequency provided to the IP block during the processing of the workload and (ii) a number of cycles during which the at least one operating frequency is provided, to a frequency pattern; and
providing a second operating frequency to the IP block, based on determining the correspondence to the frequency pattern.

10. The operating method of claim 9, wherein providing the second operating frequency to the IP block comprises providing the second operating frequency to the IP block by omitting temperature sensing for the IP block.

11. The operating method of claim 9, wherein the second operating frequency comprises a frequency lower than the first operating frequency.

12. The operating method of claim 9, comprising generating past temperature information of the IP block by sensing a temperature of the IP block,
wherein generating the past temperature information is performed based on the correspondence to the frequency pattern is determined during determining the correspondence to the frequency pattern.

13. The operating method of claim 9,
wherein determining the correspondence to the frequency pattern comprises determining that the at least one operating frequency and the number of cycles during which the at least one operating frequency is provided correspond to the frequency pattern, by referring to a dynamic voltage and frequency scaling (DVFS) table, and
wherein providing the second operating frequency to the IP block comprises providing the second operating frequency to the IP block during a number of cycles corresponding to the second operating frequency, by referring to the DVFS table.

14. The operating method of claim 9,
wherein determining the correspondence to the frequency pattern is performed based on a dynamic voltage and frequency scaling (DVFS) neural network configured to:
receive, as input data, the at least one operating frequency and the number of cycles during which the at least one operating frequency is provided;
perform training based on the input data; and
output, as output data, the second operating frequency and a threshold cycle corresponding to the second operating frequency, and
wherein providing the second operating frequency to the IP block comprises providing the second operating frequency to the IP block during a number of cycles corresponding to the threshold cycle of the second operating frequency based on the output data of the DVFS neural network.

15. A system comprising:
an intellectual property (IP) block; and
a dynamic voltage and frequency scaling (DVFS) controller configured to calculate a workload of the IP block and control an operating frequency provided to the IP block to process the workload,
wherein the DVFS controller is configured to:
determine a predetermined frequency pattern, before a first time point, corresponding to at least one pre-operating frequency provided to the IP block and a number of cycles during which the at least one pre-operating frequency is provided;
determine a post-operating frequency at the first time point based on the predetermined frequency pattern; and
provide the post-operating frequency to the IP block.

16. The system of claim 15, wherein the DVFS controller is configured to omit an operation of receiving temperature information according to temperature detection of the IP block before the first time point.

17. The system of claim 15, comprising:
a temperature sensor configured to detect a temperature of the IP block and obtain temperature information for the IP block;
wherein the DVFS controller is configured to receive past temperature information, after the first time point, according to temperature sensing for the IP block, and
wherein the past temperature information comprises the temperature information for the IP block detected near the first time point.

18. The system of claim 17, wherein the DVFS controller is configured to determine the predetermined frequency pattern based on the received past temperature information.

19. The system of claim 15, comprising a memory device configured to store a DVFS table including the predetermined frequency pattern.

20. The system of claim 15, comprising a memory device configured to store parameters of a DVFS neural network configured to:
receive, as input data, the at least one pre-operating frequency and the number of cycles of the IP block having been provided with the at least one pre-operating frequency; and
perform training based on the input data, and output, as output data, the post-operating frequency and a threshold cycle corresponding to the post-operating frequency.
